(19) United States
(12) Patent Application Publication
(10) Pub. No.: US 2025/0170798 A1
(43) Pub. Date: May 29, 2025

(54) Interior Component Comprising a Carrier Element and a Textile Top Layer Arranged on the Carrier Element, and a Method for Producing the Interior Component

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE)

(21) Appl. No.: 18/959,855

(22) Filed: Nov. 26, 2024

(30) Foreign Application Priority Data
Nov. 27, 2023 (DE) 10 2023 132 965.0

(51) Int. Cl. B32B 5/26; B32B 5/02; D04B 1/10; D04B 1/22; D04B 21/20

(52) U.S. Cl. CPC B32B 5/263; B32B 5/026; D04B 1/102; D04B 1/22; D04B 21/20; B32B 2307/51; B32B 2605/003; D10B 2401/061; D10B 2505/12

(57) ABSTRACT

An interior component of a motor vehicle includes a carrier element and a textile top layer arranged on the carrier element. The textile top layer is an interlooped material. The textile top layer includes at least one elastic stretching portion including an elastic loop construction. The textile top layer is arranged and/or fixed on the carrier element such that the elastic stretching portion of the textile top layer is elastically stretchable.

### CROSS REFERENCE TO RELATED APPLICATION

This application claims priority under 35 U.S.C. § 119 from German Patent Application No. DE 10 2023 132 965.0, filed Nov. 27, 2023, the entire disclosure of which is herein expressly incorporated by reference.

### BACKGROUND AND SUMMARY

The invention relates to an interior component comprising a carrier element and a textile top layer arranged on the carrier element, and to a method for producing the interior component.

In particular in the case of interior components of a motor vehicle, textiles, in particular 2D and/or 3D knitted fabrics, are used as surface material or as a top layer which is arranged or fixed on a carrier element of the interior component.

However, a stretchable embodiment of textile top layers is currently implementable only through subsequent processes in the production or through the use of elastic yarns.

The invention is therefore based on the object of overcoming the aforementioned disadvantages and of providing an interior component comprising a textile top layer and a method for producing the interior component, in which the textile top layer is elastically stretchable at least in certain regions.

This object is achieved by the claimed invention.

The basic concept of the invention is that a textile top layer of an interior component comprises at least one elastic stretching portion, in which the elasticity of the stretching portion is implemented without additional, in particular elastic, materials, but rather an elastic loop construction is formed directly in the production process for the textile top layer is provided by way of a suitable knitting technique. This in particular involves producing a 2D or 3D knitted fabric by way of a knitting machine, in particular a flat knitting machine. In addition, this in particular involves using a non-elastic yarn rather than an elastic yarn.

The feature “loop construction” refers to the way in which textiles, in particular knitted products, are produced. In the loop construction, loops of yarns are interwoven, producing a woven fabric.

The elasticity of loop-construction textiles is dependent on various factors, including the yarn used, the knitting pattern and the knitting technique. However, it is important to note that not all woven loop-construction fabrics have the same elasticity. Embodiments of the invention utilize the textile top layer property of the elasticity varying depending on the type of knitting pattern and the yarn. Some loop constructions are highly stretchable, whereas others are less stretchable.

In the context of embodiments of the present invention, a distinction is made between an elastic and a non-elastic loop construction.

A non-elastic loop construction or a non-elastic knitting pattern is a loop construction in which the resulting knitwork is generally less stretchable and cannot be stretched as easily as in the case of elastic knitting patterns.

An elastic loop construction is a knitting technique in which the end product has a high degree of elasticity, meaning that it can be easily stretched and then returns to its original shape. There are various knitting patterns and knitting techniques which can produce an elastic loop construction. In the context of embodiments of the present invention, stretching by at least 20% of the extent in a non-stretched state is in particular possible in the case of an elastic loop construction.

Advantages of an elastic stretching portion of a textile top layer are for example that the elastic stretching portion has a high degree of stretchability and reversibly returns to its original shape when the stretching is released. Furthermore, an elastic stretching portion has a good degree of adaptability to a carrier element of the interior component. The textile top layer is also arranged and/or fixed on the carrier element in such a way that at least the elastic stretching portion of the textile top layer is also elastically stretchable in a mounted state.

The invention therefore proposes an interior component, in particular of a motor vehicle, comprising a carrier element and a textile top layer arranged on the carrier element. The textile top layer is an interlooped material and comprises at least one elastic stretching portion. The at least one elastic stretching portion of the textile top layer comprises an elastic loop construction. The textile top layer is also arranged and/or fixed on the carrier element in such a way that at least the elastic stretching portion of the textile top layer is elastically stretchable.

In an advantageous embodiment variant of the invention, provision is made for the textile top layer to comprise at least one further and/or a plurality of further elastic stretching portions.

In an exemplary embodiment of the invention, provision is made for the elastic stretching portions to extend parallel to one another along the textile top layer and/or to be formed and/or arranged in a predetermined pattern, in particular a honeycomb structure, in the form of a polygon or in the form of a trapezoid.

Preferably, the interior component is formed in such a way that at least one elastic stretching portion of the textile top layer comprises at least one folding region with at least one fold.

In a further advantageous variant, provision is made according to the invention for a fastener for fixing the textile top layer in a stretched state to be provided.

Furthermore, an embodiment in which the textile top layer comprises an integrated, in particular a knitted-in, facing element is favorable.

In a preferred embodiment of the invention, an opening is formed in the textile top layer. The opening is arranged in particular in the at least one elastic stretching portion, more particularly is slit, unraveled and/or was formed during the knitting of the textile top layer. It is furthermore advantageous for a receptacle, preferably a pocket, a compartment, a glove compartment and/or a center console, to be arranged in particular at the opening.

In a further advantageous variant, provision is made for the entire textile top layer to be formed from one or a plurality of elastic stretching portions.

In a preferred exemplary embodiment, the interior component according to the invention is formed such that the elastic loop construction of the elastic stretching portion is a rib stitch pattern, a cable stitch pattern, a lozenge stitch pattern, a wave stitch pattern, a jersey stitch pattern and/or a stockinette stitch pattern. These embodiments of the loop construction are particularly suitable for the implementation of an elastic loop construction.

The rib stitch pattern, in which knit stitches and purl stitches are alternatingly knitted (two knit stitches followed by two purl stitches), is highly elastic, and provides the most elastic loop construction. Although the cable stitch pattern is normally not as elastic as the rib stitch pattern, it nevertheless offers a certain degree of stretchability. The elasticity is in this case dependent on the number of cables and their size. With the lozenge stitch pattern (double stitch), highly elastic woven fabrics can be produced since they consist of two layers of material. Double stitch can thus be used for stretchable and reversible materials. Wave stitch patterns produce an elastic woven fabric with a wavy design. These patterns are not as elastic as rib stitch patterns, but still offer a certain degree of stretchability. An elastic stretching portion produced using the jersey stitch pattern or stockinette stitch pattern can also have a sufficient degree of elastic stretchability for the implementation of the invention, although stockinette-knitted stitches are less elastic than rib stitch patterns. Equally, the rib stitch loop construction.

The elasticity of a piece of knitwork is dependent not only on the knitting technique selected but also on factors such as the yarn used, the needle size and the knitting tension. In order to achieve the desired elasticity in your knitting project, it may be helpful to experiment with different knitting techniques and settings.

In an exemplary embodiment of the invention, provision is made for the textile top layer to be formed from a non-elastic yarn. In the context of embodiments of the invention, a distinction is made between elastic and non-elastic yarns. Elastic yarns often contain synthetic fibers such as elastane (Spandex) or rubber, which impart the elasticity to the yarn. These yarns can be stretched and then return to their original shape. Non-elastic yarns, in particular composed of natural fibers such as cotton, linen or silk, are generally not elastic to an appreciable extent. Although these non-elastic yarns can be stretched, they usually do not return, or do not completely return, to their original shape.

In preferred embodiment variants, the interior component according to the invention is formed and/or applicable as car seat, steering column trim, map pocket, door pocket, glove compartment, roof liner, covering, trims, center console and/or trunk net replacement element.

The invention also proposes a method for producing an interior component, in particular of a motor vehicle, according to the disclosure above, comprising a carrier element and a textile top layer arranged on the carrier element. This involves producing the textile top layer by way of a knitting machine, in particular a flat knitting machine. The at least one elastic stretching portion is also formed during the production of the textile top layer. Furthermore, the textile top layer is arranged and/or fixed on the carrier element in such a way that at least the elastic stretching portion of the textile top layer is elastically stretchable.

The features disclosed above can be combined as desired, insofar as this is technically possible and they are not mutually exclusive.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic view of two interior components comprising a carrier element and a textile top layer arranged on the carrier element.

FIG. 2 shows a perspective view of the textile top layer of the interior components.

FIG. 3 shows a schematic view of a further interior component comprising a carrier element and a textile top layer arranged on the carrier element.

### DETAILED DESCRIPTION OF THE DRAWINGS

The figures are illustrative and schematic. Identical reference designations in the figures indicate identical functional and/or structural features.

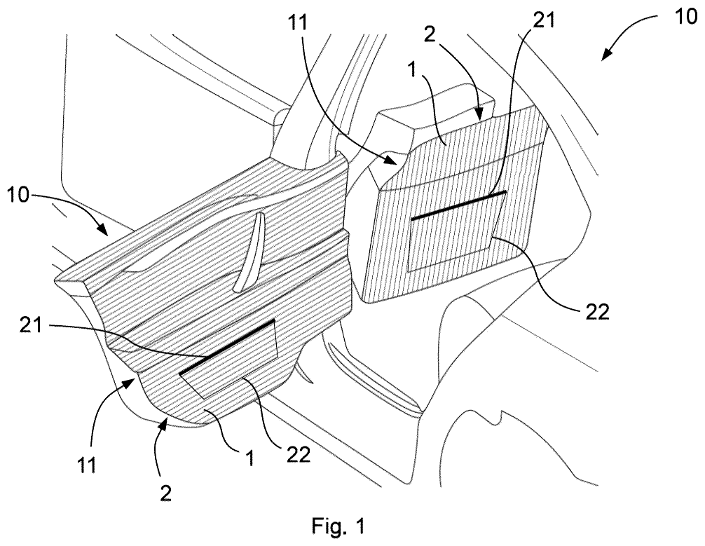

FIG. 1 illustrates a perspective view of two interior components 10 of a motor vehicle, comprising a carrier element 11 and a textile top layer 1 arranged on the carrier element 11. The one interior component 10 is a car seat and the textile top layer 1 is a corresponding seat cover. The other interior component 10 is a door trim and the textile top layer 1 is a corresponding cover for the door trim.

The textile top layer 1 is an interlooped material and comprises a plurality of elastic stretching portions 2. In this case, the respective elastic stretching portion 2 of the textile top layer 1 comprises an elastic loop construction. However, the textile top layer 1 is formed from a non-elastic yarn.

Furthermore, the textile top layer 1 is arranged and/or fixed on the carrier element 11 in such a way that at least the elastic stretching portion 2 of the textile top layer 1 is elastically stretchable.

In addition, an opening 21 is formed in the respective textile top layer 1. The opening 21 is arranged in the elastic stretching portion 2, and was formed during the knitting of the textile top layer. A receptacle 22 is also arranged at the opening. The receptacle 22 is a car seat pocket.

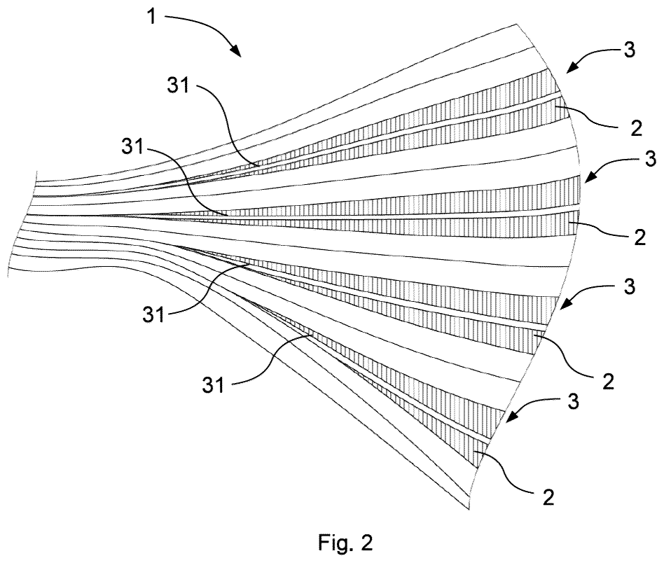

FIG. 2 shows a perspective view of a detail of the textile top layer 1 of the interior components 10 illustrated in FIG. 1.

The detail of the textile top layer 1 is shown in a non-stretched state at one end and in a stretched state at another end.

The elastic stretching portions 2 extend parallel to one another along the textile top layer 1. Each of the elastic stretching portions 2 of the textile top layer 1 also comprises a folding region 3 with at least one fold 31.

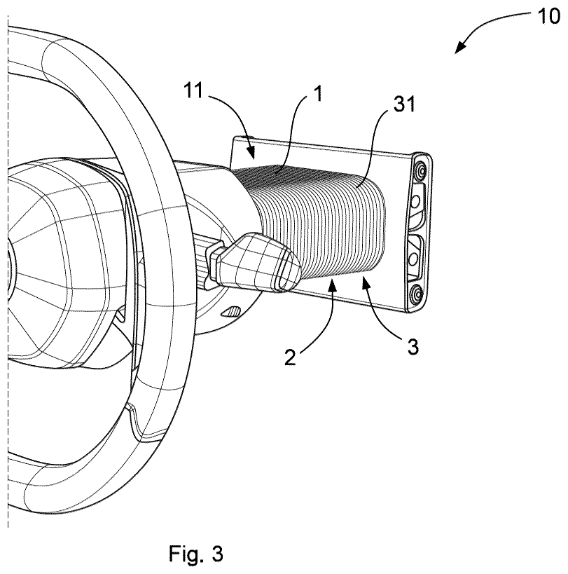

FIG. 3 illustrates a schematic view of a further interior component 10 comprising a carrier element 11 and a textile top layer 1 arranged on the carrier element. The interior component 10 is a steering column trim for a motor vehicle and the textile top layer 1 is a corresponding cover for the steering column trim.

The textile top layer 1 is an interlooped material comprising a plurality of elastic stretching portions 2. The respective elastic stretching portion 2 of the textile top layer 1 comprises an elastic loop construction, but the textile top layer 1 is formed from a non-elastic yarn. Furthermore, the textile top layer 1 is arranged and/or fixed on the carrier element 11 in such a way that at least the elastic stretching portion 2 of the textile top layer 1 is elastically stretchable, and specifically at least toward and away from the steering wheel. The elastic stretching portions 2 extend parallel to one another along the textile top layer 1. Each of the elastic stretching portions 2 of the textile top layer 1 also comprises a folding region 3 with at least one fold 31.

In terms of its execution, the invention is not limited to the preferred exemplary embodiments specified above. Instead, there is a number of conceivable variants that make use of the solution presented even in fundamentally different types of embodiment.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An interior component of a motor vehicle, the interior component comprising:
a carrier element; and
a textile top layer arranged on the carrier element, wherein:
the textile top layer is an interlooped material,
the textile top layer comprises an elastic stretching portion comprising an elastic loop construction, and
the textile top layer is arranged and/or fixed on the carrier element such that at least the elastic stretching portion of the textile top layer is elastically stretchable.

2. The interior component according to claim 1, wherein the textile top layer comprises at least one further elastic stretching portion.

3. The interior component according to claim 2, wherein the elastic stretching portion and the at least one further elastic stretching portion extend parallel to one another along the textile top layer, and/or are formed and/or arranged in a predetermined pattern in a form of a polygon or in a form of a trapezoid.

4. The interior component according to claim 3, wherein the predetermined pattern is a honeycomb structure.

5. The interior component according to claim 1, wherein the elastic stretching portion of the textile top layer comprises at least one folding region with at least one fold.

6. The interior component according to claim 1, wherein the textile top layer further comprises an integrated facing element.

7. The interior component according to claim 1, wherein the textile top layer further comprises a knitted-in facing element.

8. The interior component according to claim 1, wherein an opening is formed in the textile top layer.

9. The interior component according to claim 8, wherein the opening is arranged in the elastic stretching portion.

10. The interior component according to claim 9, wherein the elastic stretching portion is slit, unraveled or formed during knitting.

11. The interior component according to claim 9, wherein a receptacle is arranged at the opening.

12. The interior component according to claim 11, wherein the receptacle is a pocket, a compartment or a glove compartment.

13. The interior component according to claim 1, wherein the textile top layer is formed from a non-elastic yarn.

14. The interior component according to claim 1, wherein the entire textile top layer is formed from one elastic stretching portion or a plurality of elastic stretching portions.

15. The interior component according to claim 1, wherein the elastic loop construction of the elastic stretching portion is a rib stitch pattern, a cable stitch pattern, a lozenge stitch pattern, a wave stitch pattern, a jersey stitch pattern and/or a stockinette stitch pattern.

16. A method for producing the interior component according to claim 1, the method comprising:
producing the textile top layer by way of a knitting machine, wherein the elastic stretching portion is formed during production of the textile top layer; and
arranging and/or fixing the textile top layer on the carrier element such that at least the elastic stretching portion of the textile top layer is elastically stretchable.

17. The interior component according to claim 16, wherein the knitting machine is a flat knitting machine.
